(19) United States
(12) Patent Application Publication
(10) Pub. No.: US 2026/0181109 A1
(43) Pub. Date: Jun. 25, 2026

(54) HOLOGRAM BASED THREE-DIMENSIONAL PRINTING

(71) Applicant: Santec Holdings Corporation, Komaki (JP)

(72) Inventor: Changho Chong, Los Altos, CA (US)

(73) Assignee: Santec Holdings Corporation, Komaki (JP)

(21) Appl. No.: 19/422,901

(22) Filed: Dec. 17, 2025

Related U.S. Application Data
(60) Provisional application No. 63/736,978, filed on Dec. 20, 2024.

(51) Int. Cl. H04N 9/31; G02B 26/08; G03H 1/02; G03H 1/22

(52) U.S. Cl. CPC H04N 9/3105; G02B 26/0808; G03H 1/0248; G03H 1/2294

(57) ABSTRACT

A three-dimensional (3D) printing system includes an imaging system and an optical system. The imaging system includes a reservoir containing printing material, a base plate, and a motion engine configured to control a movement of the base plate. The optical system includes a light source configured to generate a source light, a light modulator configured to receive the source light and generate a modulated light, and a projection component configured to receive the modulated light and project the modulated light to form a holographic pattern on the printing material. The printing material exposed to the holographic pattern is cured to form a 3D object on the base plate.

### CROSS-REFERENCE TO RELATED APPLICATIONS

The present application claims the benefit of and priority to U.S. Provisional Ser. No. 63/736,978 , filed Dec. 20, 2024, the contents of which is incorporated by reference in its entirety for any and all purposes.

### BACKGROUND

The following description is provided to assist the understanding of the reader. None of the information provided or references cited is admitted to be prior art.

Three-dimensional (3D) printing enables rapid prototyping for research and development. Two types of 3D printing techniques, fused deposition modeling and stereolithography, can be used to print a 3D object by stacking slices layer by layer based on a source design for the 3D object. For example, when exposed to a light, printing material can be cured to form a layer of the 3D object.

### SUMMARY

The present technology provides three-dimensional printing techniques based on hologram.

One aspect of the present disclosure is directed to a three-dimensional (3D) printing system, including an imaging system and an optical system. The imaging system includes a reservoir containing printing material; a base plate; and a motion engine configured to control a movement of the base plate. The optical system includes a light source configured to generate a source light; a light modulator configured to receive the source light and generate a modulated light; and a projection component configured to receive the modulated light and project the modulated light to form a holographic pattern on the printing material. The printing material exposed to the holographic pattern is cured to form a 3D object on the base plate.

In some examples, the motion engine continuously changes a location of the base plate, and simultaneously, the holographic pattern is continuously changing.

In some examples, the holographic pattern corresponds to a two-dimensional (2D) cross section of a 3D object to be printed.

In some examples, the projection component is configured to project the modulated light to a portion of the base plate. The holographic pattern includes a focused beam spot. In some examples, the 3D printing system further includes a scanning component coupled to the projection component, the scanning component configured to scan the base plate with the modulated light such that a location of the focused beam spot changes.

In some examples, the 3D printing system further includes a polarizer disposed between the projection component and the light modulator, wherein in a first mode, the light modulator is configured to generate an intensity modulated light through the polarizer, and wherein in a second mode, the light modulator is configured to generate a phase modulated light through the polarizer.

In some examples, the 3D printing system further includes a half-wave plate disposed between the projection component and the light modulator. In some examples, the light modulator is a first light modulator, further including a second light modulator, wherein the first light modulator is configured to operate in the first mode, and the second light modulator is configured to operate in the second mode.

Another aspect of the present disclosure is directed a device for printing a 3D object including an imaging system and an optical system. The imaging system includes a reservoir containing photosensitive material; a base plate located in the reservoir; and a motion engine configured to control a movement of the base plate. The optical system includes a light source configured to generate a source light; a light modulator configured to receive the source light and generate a modulated light; and a projection component configured to receive the modulated light and project the modulated light to expose the printing material to a holographic pattern. The printing material exposed to the holographic pattern is cured to form a 3D object on the base plate.

In some examples, the device further includes an optical coherence tomography system configured to generate a 3D volumetric image of the 3D object.

In some examples, a predetermined thickness of the photosensitive material is exposed to the holographic pattern, and in response to exposure to the holographic pattern, the exposed photosensitive material is cured.

In some examples, the light modulator is configured to change a phase or intensity of a local portion of the modulated light. In some examples, the light modulator includes a liquid crystal on silicon.

In some examples, the base plate is located in the reservoir, and the motion engine continuously changes a location of the base plate, and simultaneously, the holographic pattern is continuously changing.

Another aspect of the present disclosure includes a method of printing a 3D object, including: generating, by a light source, a source light; generating, by a light modulator, a modulated light in response to receipt of the source light; projecting, by a projection component, the modulated light to form a holographic pattern, in response to receipt of the modulated light, on printing material; curing the printing material exposed to the holographic pattern; and changing, by a motion engine, a vertical position of the base plate in response to curing of the printing material.

In some examples, the method further includes continuously changing the vertical position of the base plate, and simultaneously, continuously changing the holographic pattern.

In some examples, the method further includes focusing the modulated light onto a portion of the base plate.

In some examples, the method further includes scanning the base plate with the focused modulated light.

In some examples, the generating of the method further includes modulating an intensity of the modulated light in a first mode, and modulating a phase of the modulated light in a second mode.

In some examples, the method further includes generating a 3D volumetric image of the cured printing material.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a block diagram of an example printing system for printing a three-dimensional (3D) object, in accordance with various embodiments.

FIG. 2 illustrates a schematic view of an example printing system for printing a 3D object, in accordance with various embodiments.

FIG. 3A and FIG. 3B illustrate example implementations of an example printing system for printing a 3D object, in accordance with various embodiments.

FIG. 4A and FIG. 4B illustrate example implementations of an example printing system for printing a 3D object, in accordance with various embodiments.

FIG. 5A and FIG. 5B illustrate example implementations of an example printing system for printing a 3D object, in accordance with various embodiments.

FIG. 6A and FIG. 6B illustrate example implementations of an example printing system for printing a 3D object, in accordance with various embodiments.

FIG. 7A and FIG. 7B illustrate example implementations of an example printing system for printing a 3D object, in accordance with various embodiments.

FIG. 8 illustrates a schematic view of an example printing system for printing a 3D object, in accordance with various embodiments.

FIG. 9 illustrates a schematic view of an example printing system for printing a 3D object, in accordance with various embodiments.

FIG. 10 illustrates a flow chart of an example method for printing a 3D object, in accordance with various embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

3D printing is relatively slow compared with 2D printing, due in part to an exposure process in which printing material is cured (e.g., hardened, polymerized, etc.) to form each layer of a 3D object in response to exposure to a light. The exposure time to cure the printing material is a main contributor to the printing time. However, in 3D printing, the exposure time is required to be long enough to cure the printing material, because of a low density of the light for curing the printing material. For example, in 3D printing, most of the light is not used (e.g., absorbed, reflected off, etc.) for curing, particularly when an image size is relatively small, and thus an energy density of the light per area is very low. This increases the exposure time to cure the printing material, and therefore increases the printing time.

As will be discussed in further detail below, this disclosure provides efficient 3D printing techniques using a hologram-based approach. Techniques discussed herein include an optical system to provide a holographic pattern and an imaging system to form a 3D object based on the holographic pattern. Printing material exposed to the holographic pattern can be cured to form a 3D object. This allows a light for curing (e.g., a holographic pattern) to be concentrated on an area where a 3D object is to be printed, thereby increasing an energy density of the light and thus reducing the exposure time and the printing time. Furthermore, the switching of the holographic pattern can be relatively faster, so the hologram-based 3D printing can provide a high-resolution and isotropic finish with smoother surfaces and detailed features.

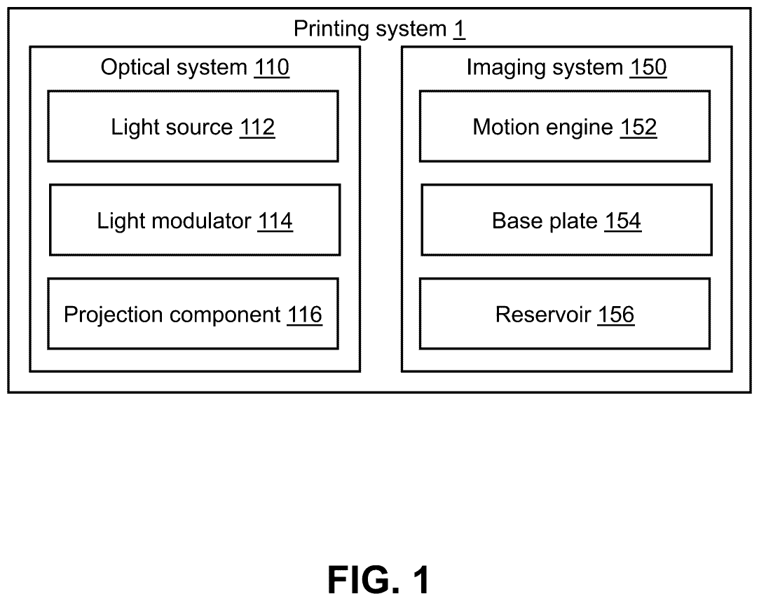

FIG. 1 illustrates a block diagram of an example printing system 1 for printing a three-dimensional (3D) object, in accordance with various embodiments. The printing system 1 includes an optical system 110 and an imaging system 150. The optical system 110 includes a light source 112, a light modulator 114, and a projection component 116. The imaging system 150 includes a motion engine 152, a base plate 154, and a reservoir 156. The optical system 110 can project a modulated light to the imaging system 150 to form a holographic pattern. The imaging system 150 can print a 3D object based on the holographic pattern.

The light source 112 can include any of various light sources that can generate a source light. For example, the light source 112 can generate a laser beam (e.g., a 405 nm laser, an ultraviolet laser, etc.). The source light of the light source 112 can be coherent, monochromatic, and/or collimated. In some examples, the light source 112 can include and/or be optically coupled to various components to generate the source light and provide the same to the light modulator 114. For example, the light source 112 can include and/or be optically coupled to a lens, a fiber, a polarizer, a halfwave plate, a collimator, etc.

The light modulator 114 can include any component that can modulate a phase and/or an intensity of an incident light (e.g., the source light) and output (e.g., reflect) the modulated light. In some examples, the light modulator 114 may be a spatial light modulator (SLM) or any electronic device that can control a phase and/or an intensity of an incident light (e.g., the source light) at various points across an optical wavefront of the incident light. By controlling a local portion of the light modulator 114 (e.g., the SLM), an incident light (e.g., the source light) can be modulated. For example, the light modulator 114 may be a liquid crystal on silicon (LCOS) SLM. The LCOS SLM can control a phase and/or an intensity of an incident light (e.g., the source light) by controlling each cell of the liquid crystal cells. In some examples, the light modulator 114 may be an electro-optic modulator (EOM) or any device that can control a polarization state of an incident light (e.g., the source light) in response to an applied voltage. The light modulator 114 can direct (e.g., reflect) the modulated light into the projection component 116. In some examples, the light modulator 114 can continuously modulate an incident light (e.g., continuously change a phase and/or an intensity of an incident light) and output (e.g., reflect) the modulated light whose phase and/or intensity are continuously changing.

The projection component 116 can include any component that can receive the modulated light from the light modulator 114 and project the modulated light (e.g., into to the imaging system 150) to form a holographic pattern (e.g., on printing material on an image plane, on the base plate 154 of the imaging system 150, etc.). In some examples, the projection component 116 may be or include, but not limited to, a lens, a mirror, a half mirror cube, a scanner, etc.

The reservoir 156 can be any container configured to contain printing material. The printing material may be or include, but not limited to, photosensitive material, liquid resin, photopolymer resin, etc. The printing material can be cured (e.g., hardened, polymerized, etc.) to form (e.g., print) a 3D object in response to exposure to the holographic pattern. The printed 3D object can be formed on the base plate 154 or on an object already formed thereon. The reservoir 156 can be formed of a transparent material or include a transparent window such that the printing material contained therein can be exposed to the holographic pattern.

The base plate 154 can be any surface (e.g., a plate, a platform, etc.) on which a 3D object is formed (e.g., printed). When printing material that is adjacent to the base plate 154 or on an image plane is exposed to the holographic pattern, the printing material can be cured (e.g., hardened, polymerized, etc.) and formed (e.g., printed, attached, etc.) on the base plate 154 or an object already formed thereon. A movement (and thus a location) of the base plate 154 can be controlled to form a 3D object. For example, a vertical location of the base plate 154 can be controlled by the motion engine 152.

The motion engine 152 can be any motion control component that can control a location of the base plate 154. The motion engine 152 can include, but not limited to, a motor, a linear translation stage/engine (e.g., a vertical axis stage/engine, a multi-axis stage/engine, etc.), etc. A range of the motion that the motion engine 152 can control is not limited. For example, the motion engine 152 can control a vertical position of the base plate 154 in any range that allows a 3D object to be printed. In some examples, the motion engine 152 can control a position of the base plate 154 as the projection component 116 projects the modulated light. For example, the motion engine 152 can change a vertical position of the base plate 154 as the projection component 116 projects the modulated light. For example, the motion engine 152 can continuously change a vertical position of the base plate 154 as the holographic pattern is continuously changing.

In some examples, the system 1 can include a computer system that initiates steps of the hologram exposure for a finite time, followed by a motion of the base plate 154 to introduce a volume of printing material into a vacated space.

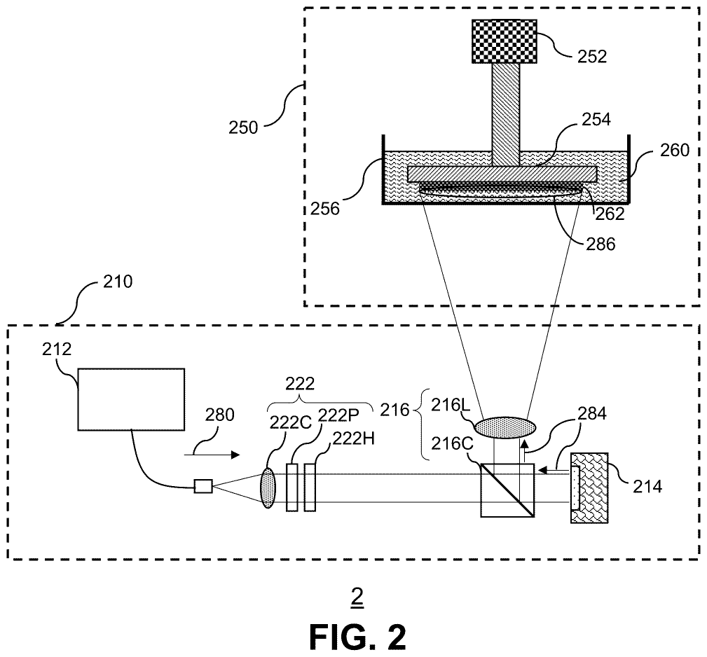

FIG. 2 illustrates a schematic view of an example printing system 2 for printing a 3D object, in accordance with various embodiments. The printing system 2 may be substantially similar to and/or incorporate features of the printing system 1. For example, an optical system 210, a light source 212, a light modulator 214, and a projection component 216 may be substantially similar to or incorporate features of the optical system 110, the light source 112, the light modulator 114, and the projection component 116, respectively. For example, an imaging system 250, a motion engine 252, a base plate 254, and a reservoir 256 may be substantially similar to or incorporate features of the imaging system 150, the motion engine 152, the base plate 154, and the reservoir 156, respectively. The system 2 can additionally include an input component 222.

In a brief overview, the light source 212 can provide an incident light 280 through the input component 222. The light modulator 214 can receive the incident light 280 and output a modulated light 284 to the projection component 216. The projection component 216 can direct the modulated light 284 to the imaging system 250 to form a holographic pattern 286. Printing material 260 exposed to the holographic pattern 286 can be cured and form a 3D object 262.

The light source 212 can be optically coupled to the input component 222 to provide the incident light 280 to the light modulator 214. As shown, the light source 212 can direct the incident light 280 to the input component 222, which then can adjust an optical path and/or a property (e.g., an intensity, a phase, a polarization state, etc.) of the incident light 280. The input component 222 can include a collimating lens 222C to collimate the incident light 280. The input component 222 can include a polarizer 222P to selectively filter a polarization state of the incident light 280. For example, the incident light 280 can become linearly polarized when passing through the input component 222. For example, the polarization state of the incident light 280 can be horizontal to the longer axis of the light modulator 214 (e.g., the longer axis of the SLM). The input component 222 can include a halfwave plate 222H to adjust a phase and/or a polarization state of the incident light 280. In some examples, the light source 212 can direct the incident light 280 to the collimating lens 222C through an optical fiber.

In some examples, as shown in FIG. 2, the incident light 280 can be provided to the light modulator 214 through a portion of the projection component 216. For example, the projection component 216 can include a half mirror cube 216C (e.g., an optical half mirror cube, a beam splitter cube, etc.) that allows the incident light 280 to travel to the light modulator 214 while directing the modulated light 284 to the imaging system 250. The projection component 216 can include a projection lens 216L. The projection lens 216L can project the modulated light 284 to the imaging system 250, more specifically, to the printing material 260 on an image plane or to the base plate 254.

In response to projection of the modulated light 284, the holographic pattern 286 is formed on an image plane (e.g., on or adjacent to the base plate 254, etc.). The printing material 260 exposed to the holographic pattern 286 can be cured (e.g., hardened, polymerized, etc.) to form (e.g., print) the 3D object 262 on the image plane. For example, the printing material 260 exposed to the holographic pattern 286 can be cured (e.g., hardened, polymerized, etc.) to form (e.g., print) the 3D object 262 on the base plate 254 (or on a 3D object that has been printed thereon).

The motion engine 252 can control the motion (and/or the location) of the base plate 254 based on curing of the printing material 260. In some examples, the motion engine 252 can control a vertical position of the base plate 254 as the projection component 216 projects the modulated light 284. For example, the motion engine 252 can continuously change the vertical position of the base plate 254 as the holographic pattern 286 is continuously changing.

In some examples, the diameter, D, of the incident light 280 incident to the light modulator 214 can be calculated as: D=2×f×NA, where f is the focal length of the projection lens 216L and NA is the numerical aperture of the optical fiber.

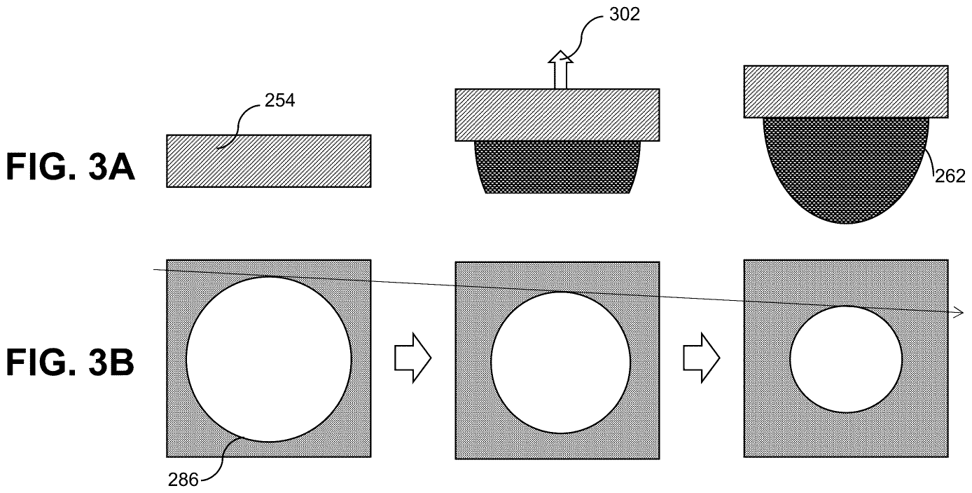

FIG. 3A and FIG. 3B illustrate example implementations of an example printing system for printing a 3D object, in accordance with various embodiments. Although discussed with respect to the system 2 of FIG. 2, the implementations shown in FIG. 3A and FIG. 3B can be performed with any of devices, systems, or methods disclosed herein (e.g., the system 1). FIG. 3A shows a motion 302 of the base plate 254 and the 3D object 262 being printed thereon. FIG. 3B shows the holographic pattern 286 to cure the printing material to form the 3D object 262. The position of the base plate 254 can be continuously changing in response to formation of the holographic pattern 286. For example, the motion engine 252 can control the motion 302 to continuously change a vertical position of the base plate 254. The light modulator 214 can simultaneously provide the projection component 216 with the modulated light 284 continuously changing, thereby forming the holographic pattern 286 continuously changing. A temporal resolution for changing the holographic pattern 286, in some examples, may be less than 5 ms (e.g., 4.8 ms). Since the holographic pattern 286 does not have a pixel-limited resolution, the implementations shown in FIG. 3A and FIG. 3B allow for formation of smooth surfaces (rather than step-by-step surfaces) of the 3D object 262. The continuously changing holographic pattern 286 and the responsive motion of the base plate 254 can further improve a resolution and/or a surface profile (e.g., smoothness) of a 3D object.

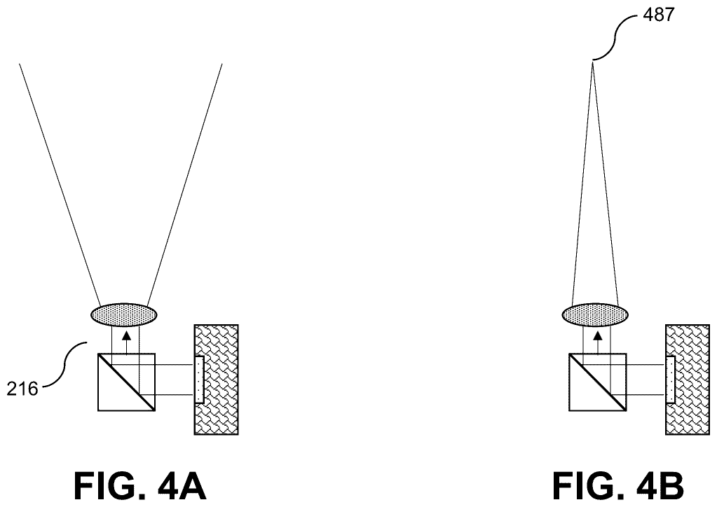

FIG. 4A and FIG. 4B illustrate example implementations of an example printing system for printing a 3D object, in accordance with various embodiments. Although discussed with respect to the system 2 of FIG. 2, the implementations shown in FIG. 4A and FIG. 4B can be performed with any of devices, systems, or methods disclosed herein (e.g., the system 1). The projection component 216 can operate in various modes. The projection component 216 can operate in a first mode as shown in FIG. 4A. The projection component in the first mode can project the modulated light to an area that covers the entire surface of the base plate 254 (or of the 3D object 262 being printed). For example, the projection component 216 can project the modulated light such that the printing material 260 being cured in response to exposure to the holographic pattern 286 corresponds to a two-dimensional (2D) cross section of the 3D object 262 being printed.

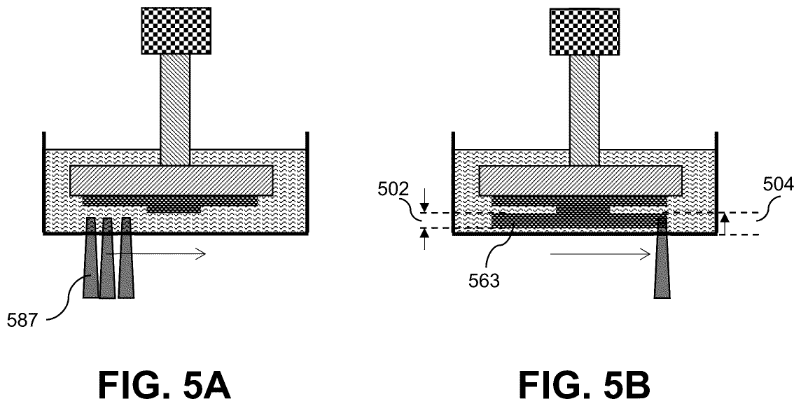

The projection component 216 can operate in a second mode as shown in FIG. 4B. The projection component 216 in the second mode can project the modulated light to a local area 487 that covers a local surface of the base plate 254 (or of the 3D object 262 being printed). In the second mode, only printing material that is located in or nearby the local area 487 can be cured, thereby locally forming a portion of the 3D object 262. For example, the projection lens 216L of the projection component 216 can project the modulated light to the local area 487 that covers only a portion of an image plane. In some examples, the projection component 216 can include a scanning component (not shown) that can control a location of the local area 487. The scanning component of the projection component 216 can scan an image plane or a portion thereof with a focused beam (e.g., FIG. 5A, FIG. 5B). In some examples, the projection component 216 can scan an image plane or a portion thereof with a focused beam by changing a shape, a position, a focal length, etc. of a Fresnel lens. In some examples, although only one local area 487 is depicted in FIG. 4B, the projection component 216 in the second mode can project the modulated light to a plurality of focused areas.

In some examples, the printing system described herein (e.g., the systems 1, 2) can be controlled to switch between the first mode and the second mode. In some examples, the printing system described herein (e.g., the systems 1, 2) can be controlled to operate simultaneously both in the first mode and the second mode. For example, the projection component 216 can project a modulated light corresponding to a 2D cross section of the 3D object 262 being printed while projecting a focused modulated light to form a fine structure of the 3D object 262 being printed.

FIG. 5A and FIG. 5B illustrate example implementations of an example printing system for printing a 3D object, in accordance with various embodiments. Although discussed with respect to the system 2 of FIG. 2, the implementations shown in FIG. 5A and FIG. 5B can be performed with any of devices, systems, or methods disclosed herein (e.g., the system 1). FIG. 5A shows a portion of the system 2 at a first time, and FIG. 5B shows the portion of the system 2 at a second time. For example, the projection component 216 can scan an image plane with a focused light 587 from the first time (FIG. 5A) to the second time (FIG. 5B). The focused light 587 forms a holographic pattern in the scanned area. The printing material exposed to the holographic pattern can be cured and form a 3D object 563. As shown in FIG. 5B, the 3D object 563 can be formed on a pre-printed 3D object.

In some examples, the holographic pattern can cure the printing material located at a predetermined depth 504. The focused light 587 can form the holographic pattern at the predetermined depth 504, thereby forming a 3D object at the predetermined depth 504, as shown in FIG. 5B. In some examples, the holographic pattern can cure the printing material to form a 3D object having a predetermined thickness 502. The focused light 587 can form the holographic pattern to cure the printing material of the predetermined thickness 502, as shown in FIG. 5B.

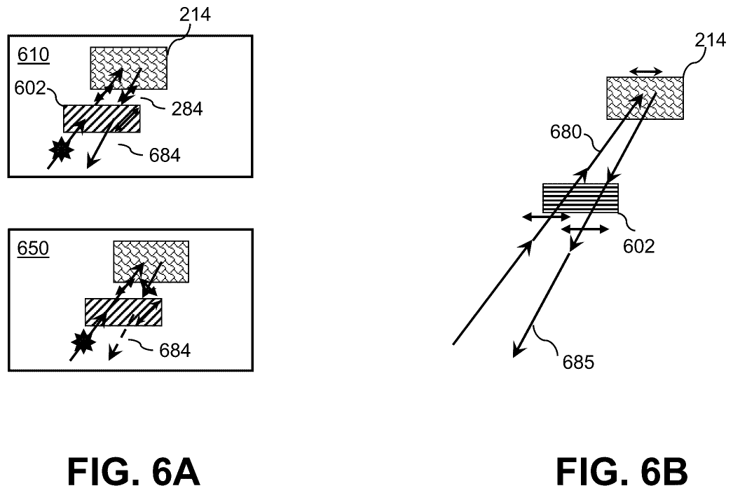

FIG. 6A and FIG. 6B illustrate example implementations of an example printing system for printing a 3D object, in accordance with various embodiments. Although discussed with respect to the system 2 of FIG. 2, the implementations shown in FIG. 6A and FIG. 6B can be performed with any of devices, systems, or methods disclosed herein (e.g., the system 1). FIG. 6A shows implementations of the system 2 in a first mode (e.g., intensity modulation), and FIG. 6B shows implementations of the system 2 in a second mode (e.g., phase modulation).

Referring to FIG. 6A, the system 2 can operate in the first mode (e.g., intensity modulation). The light modulator 214 can be additionally optically coupled to a polarizer 602. In a first state 610, the light modulator 214 can rotate a polarization of the incoming light such that the modulated light 284 has a first polarization. The modulated light 284 can pass through the polarizer 602, and the intensity of the modulated light 684 can be controlled based on the rotated polarization of the modulated light 284 and the orientation of the polarizer 602. For example, when the first polarization of the modulated light 284 aligns with the orientation of the polarizer 602, the modulated light 684 can have the light intensity identical to that of the modulated light 284. When the first polarization of the modulated light 284 does not align with the orientation of the polarizer 602 (e.g., in a state 650), the modulated light 684 can have the light intensity smaller than that of the modulated light 284. As such, the polarizer 602, the modulator 214, etc. can be configured to modulate the intensity of the modulated light 684.

Referring to FIG. 6B, the system 2 can operate in the second mode (e.g., phase modulation). In the second mode, the light modulator 214 can be controlled to change a refractive index of a local portion of the light modulator 214. For example, the light modulator 214 may be a LCOS, and each pixel of the LCOS can be modulated to change the refractive index of the pixel. The change in the local refractive index changes an optical path length of a wavefront of the incident light 680 incident on the local portion, thereby modulating the wavefront of the incident light 680 and providing a phase-modulated light 685. The relative orientation of the optical axis of the light modulator 214 with respect to the optical axis of the polarizer 602 can be fixed (e.g., both at 0 degree).

In some examples, the system 2 can operate in a mode that combines the first mode and the second mode. For example, the system 2 can operate in the first mode at a first time, and operate in the second mode at a second time. For example, the system 2 can include a set of light modulators, one of which operates in the first mode and the other operates in the second mode.

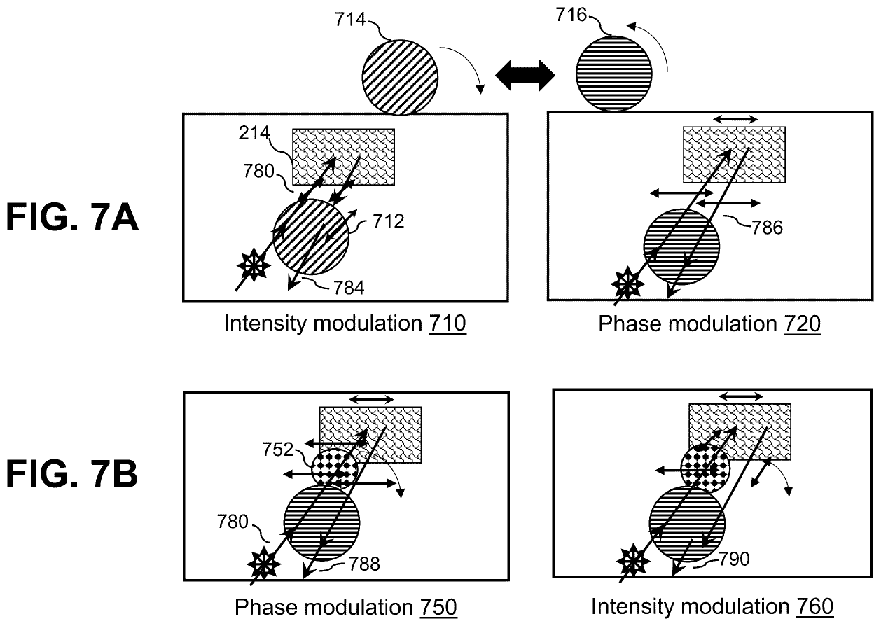

FIG. 7A and FIG. 7B illustrate example implementations of an example printing system for printing a 3D object, in accordance with various embodiments. Although discussed with respect to the system 2 of FIG. 2, the implementations shown in FIG. 7A and FIG. 7B can be performed with any of devices, systems, or methods disclosed herein (e.g., the system 1). In FIG. 7A and FIG. 7B, the system 2 can be configured to operate in the first mode (e.g., intensity modulation) and the second mode (phase modulation). The modes of the system 2 can be switched using, for example, a polarizer 712 (as shown in FIG. 7A) or a half-wave plate (as shown in FIG. 7B).

Referring to FIG. 7A, the polarizer 712 can be used to switch the operating mode of the system 2. In the first mode (e.g., intensity modulation 710), the polarizer 712 can be a rotating polarizer, and the rotation of the polarizer 712 can adjust the intensity of an intensity-modulated light 784. In some examples, the polarizer 712 can be fixed at a first orientation 714, and the system 2 can include another component to adjust the intensity of the intensity-modulated light 784. In the second mode (e.g., phase modulation 720), the polarizer 712 can be fixed at a second orientation 716. For example, the orientation of the polarizer 712 can be fixed to be parallel to the optical axis of the light modulator 214. For example, an angular difference between the second orientation 716 and the first orientation 714 may be 45 degrees. In the second mode, the light modulator 214 can change a local refractive index of the light modulator 214. For example, the light modulator 214 may be a LCOS, and each pixel of the LCOS can be modulated to change the local refractive index. The change in the local refractive index can change an optical path length of a wavefront of the incident light 780 incident on the local portion and shift a phase of the local wavefront, thereby modulating the wavefront of the incident light 780 and providing a phase-modulated light 786.

Referring to FIG. 7B, the half-wave plate 752 can be used to switch the mode of the system 2. The half-wave plate 752 can be disposed between the light modulator 214 and the polarizer 712, such that the incident light 780 passes through the half-wave plate 752 when entering the light modulator 214.

In the first mode (e.g., phase modulation 750), the orientation of the half-wave plate 752, the orientation of the polarizer 712, and the optical axis of the light modulator 214 can be fixed at a certain orientation. For example, the orientation of the half-wave plate 752, the orientation of the polarizer 712, and the optical axis of the light modulator 214 can be parallel to one another, such that a polarization state of the incident light 780 that enters the light modulator 214 can be constant. The light modulator 214 can change a local refractive index of the light modulator 214. For example, the light modulator 214 may be a LCOS, and each pixel of the LCOS can be modulated to change the local refractive index. The change in the local refractive index can change an optical path length of a wavefront of the incident light 780 incident on the local portion and shift a phase of the local wavefront, thereby modulating the wavefront of the incident light 780 and providing a phase-modulated light 788. In the second mode (e.g., intensity modulation 760), the half-wave plate 752 can be rotated. The rotation of the half-wave plate 752 can adjust the intensity of an intensity-modulated light 790. In the second mode (e.g., intensity modulation 760) of FIG. 7B, the half-wave plate 752 can rotate a polarization state of the incident light 780 (e.g., by 45 degrees).

In some examples, as shown in FIG. 7A and FIG. 7B, the system 2 can be configured to operate both in the first mode (e.g., intensity modulation 710, phase modulation 750) and in the second mode (e.g., phase modulation 720, intensity modulation 760) with a single configuration using optical components (e.g., the polarizer 712, half-wave plate 752, etc.). This allows the system 2 to select a mode depending on a shape, a type, or complexity of a 3D object to be printed. For an example, if a surface of the 3D object includes relatively simple straight lines or sides, the intensity modulation (e.g., 710, 760) can be used, while the phase modulation (e.g., 720, 750) may be used for complex surfaces. In some examples, the system 2 can combine or switch between the two modes (e.g., intensity modulation, phase modulation) while printing a 3D object. For example, the system 2 can operate in the first mode for a first position or a first local shape of a 3D object, and operate in the second mode for a second position or a second local shape of the 3D object.

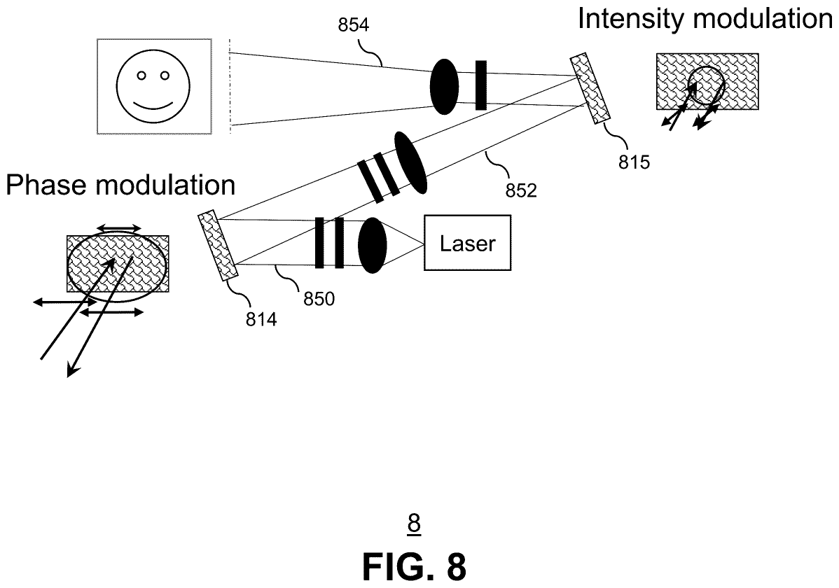

FIG. 8 illustrates a schematic view of an example printing system 8 for printing a 3D object, in accordance with various embodiments. The system 8 may be substantially similar to and/or incorporate features of the printing system 1 and/or the printing system 2. The system 8 can additionally include a plurality of light modulators. As shown in FIG. 8, the system 8 can include a first light modulator 814 and a second light modulator 815. The first light modulator 814 and the second light modulator 815 may be substantially similar to and/or incorporate features of the light modulator 214. The system 8 can include any optical components described with respect to FIGS. 5A, 5B, 6A, 6B, 7A, and 7B. For example, the system 8 can include a polarizer (e.g., 712), a half-wave plate (e.g., 752), etc.

The system 8 can operate in a mode that combines the first mode and the second mode described with respect to FIGS. 5A, 5B, 6A, 6B, 7A, and 7B. The first light modulator 814 can receive an incident light 850, modulate the incident light 850, and provide a first-modulated light 852 to the second light modulator 815. The second light modulator 815 can receive the first-modulated light 852, further modulate the first-modulated light 852, and provide a second-modulated light 854 to an imaging system (e.g., the imaging system 250). In some examples, the first light modulator 814 can modulate a phase or an intensity of the incident light 850, while the second light modulator 815 can modulate an intensity or a phase of the first-modulated light 852. For example, the first light modulator 814 can receive the incident light 850, modulate a phase of the incident light 850, and provide the first-modulated light 852 (phase modulated) to the second light modulator 815. The second light modulator 815 can receive the first-modulated light 852 (phase modulated), modulate an intensity of the first-modulated light 852, and provide the second-modulated light 854 (phase modulated by the first light modulator 814, and intensity modulated by the second light modulator 815) to an imaging system (e.g., the imaging system 250). In these examples, the first light modulator 814 for phase modulation can localize illumination on an object area of the second light modulator 815, and the second light modulator 815 can modulate the intensity to tune detailed images/features of the 3D object to be printed. This allows for high efficiency and high resolution.

In some examples, the first light modulator 814 can receive the incident light 850, modulate an intensity of the incident light 850, and provide the first-modulated light 852 (intensity modulated) to the second light modulator 815. The second light modulator 815 can receive the first-modulated light 852 (intensity modulated), modulate a phase of the first-modulated light 852, and provide the second-modulated light 854 (intensity modulated by the first light modulator 814, and phase modulated by the second light modulator 815) to an imaging system (e.g., the imaging system 250).

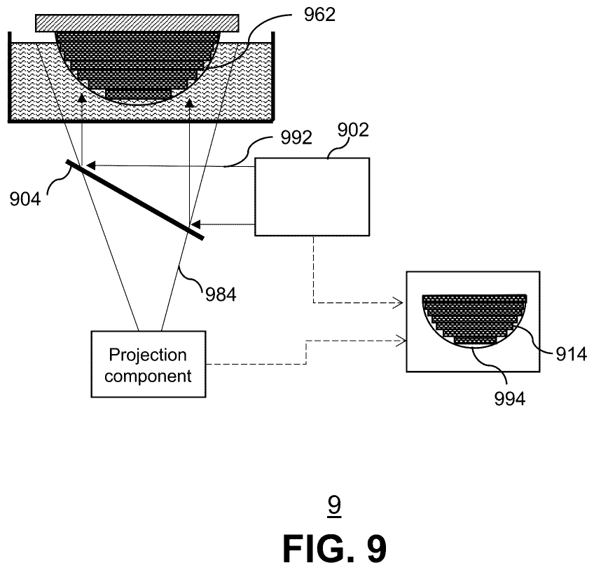

FIG. 9 illustrates a schematic view of an example printing system 9 for printing a 3D object, in accordance with various embodiments. The system 9 may be substantially similar to and/or incorporate features of the printing system 1 and/or the printing system 2. The system 9 can additionally include an optical measurement component 902.

The optical measurement component 902 may be or include any component, device, or system that can determine a property of a 3D object 962. In some examples, the optical measurement component 902 may be an optical coherence tomograph (OCT). The OCT can generate a 3D volumetric image (e.g., an internal structure, a 3D surface profile, etc.) of the 3D object 962. The optical measurement component 902 can be configured to determine a property of the 3D object 962 by measuring a property of the 3D object 962 with a second light 992. For example, the optical measurement component 902 can direct the second light 992 through a coupling component 904 and receive a reflected light, without affecting a modulated light 984. For example, the coupling component 904 may be a dichroic mirror that can direct the second light 992 from the optical measurement component 902 into the 3D object 962 and direct a reflected light into the optical measurement component 902, while allowing the modulated light 984 to pass through. The second light 992 may be at a wavelength different from the wavelength of the modulated light 984. For example, the second light 992 may be an infrared light. In some examples, the optical measurement component 902 (e.g., OCT) can measure a structural property (e.g., an internal structure, a 3D surface profile, etc.) of the 3D object 962 during and/or after a printing of the 3D object 962. In some examples, a measured volumetric image/shape (e.g., an internal structure, a 3D surface profile, etc.) can be feedbacked to optimize the printing condition and/or inspect a quality of a result of the printing. For example, as shown, a measured 3D image 994 (e.g., an OCT image) can be compared with a design 914 of the 3D object 962 (e.g., slices).

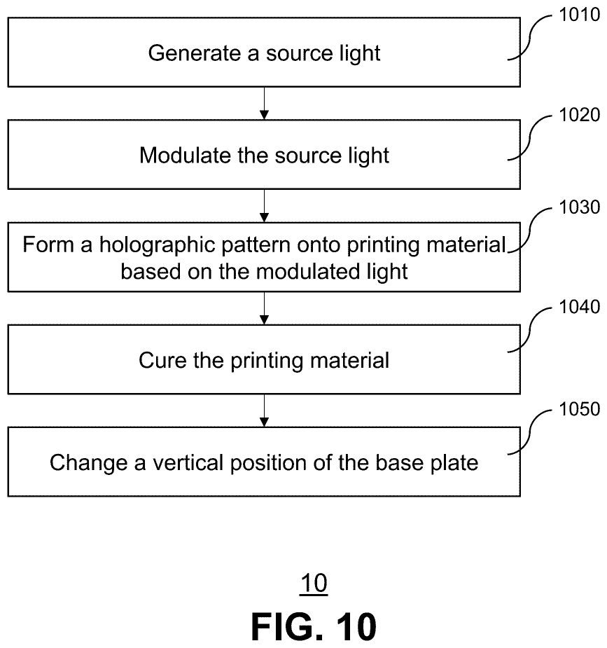

FIG. 10 illustrates a flow chart of an example method 10 for printing a 3D object, in accordance with various embodiments. The method 10 can be performed using any of the devices, systems, or components thereof disclosed with respect to FIG. 1 to FIG. 9. For example, the method 10 can be performed using the systems 1, 2.

In brief overview, the method 10 can start with operation 1010 of generating a source light. The method 10 can continue to operation 1020 of modulating the source light. The method 10 can continue to operation 1030 of forming a holographic pattern onto printing material based on the modulated light. The method 10 can continue to operation 1040 of curing the printing material. The method 10 can continue to operation 1050 of changing a vertical position of the base plate. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments

At operation 1010, a light source (e.g., 212) can generate a source light (e.g., 280). In some examples, the source light can be polarized, collimated, or pre-modulated. At operation 1010, the generated source light can be directed to a light modulator (e.g., 214). In some examples, the source light can be directed to the light modulator through an optical component, for example, a lens, a collimator, a polarizer, etc.

At operation 1020, the source light can be modulated, in response to receipt of the source light. A phase, an intensity, a polarization state, etc. of the source light or a local portion (e.g., a local wavefront) thereof can be modulated. In some examples, the source light can be modulated at a first time, and can be further modulated at a second time. For example, an intensity of the source light can be modulated, and subsequently a phase of the intensity-modulated light can be modulated. For example, a phase of the source light can be modulated, and subsequently an intensity of the phase-modulated light can be modulated. At operation 1020, in response to modulating of the source light, a modulated light can be directed to printing material (e.g., 260) through an optical component (e.g., the projection component 216).

At operation 1030, the modulated light can form a holographic pattern (e.g., 286) on an image plane of the printing material. In some examples, the holographic pattern can be formed on a base plate (e.g., 254). In some examples, the holographic pattern can be formed on an image plane of the printing material. In some examples, the holographic pattern can be formed on an object that has been printed. In some examples, the holographic pattern can be formed at a predetermined depth (e.g., 504) of the printing material. In some examples, the holographic pattern can be formed with a predetermined thickness (e.g., 502). In some examples, the holographic pattern can be formed over an entire area of a 3D object being printed, for example, as shown in FIG. 4A. In some examples, the holographic pattern can be formed on a local spot of a 3D object being printed, for example, as shown in FIG. 4B. At operation 1030, the method 10 can include scanning an area of a 3D object being printed with a holographic pattern formed on a local spot.

At operation 1040, in response to formation of the holographic pattern, the printing material exposed to the holographic pattern can be cured (e.g., hardened, polymerized, etc.) to form a 3D object (e.g., 262). In some examples, the method 10 can include measuring a property of the 3D object being printed during a printing process. For example, the method 10 can include generating a 3D volumetric image (e.g., an internal structure, a 3D surface profile, etc.) of the 3D object being printed.

At operation 1050, in response to curing of the printing material, a motion of a base plate can be controlled. A vertical position of the base plate can be controlled to change, in response to curing of the printing material. In some examples, the vertical position of the base plate can continuously change, while simultaneously, the holographic pattern can continuously change.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Additional embodiments may be set forth in the following claims.

What is claimed is:

1. A three-dimensional (3D) printing system, comprising:
an imaging system, comprising:
a reservoir containing printing material;
a base plate; and
a motion engine configured to control movement of the base plate; and
an optical system, comprising:
a light source configured to generate a source light;
a light modulator configured to receive the source light and generate a modulated light; and
a projection component configured to receive the modulated light and project the modulated light to form a holographic pattern on the printing material,
wherein the printing material exposed to the holographic pattern is cured to form a 3D object on the base plate.

2. The 3D printing system of claim 1, wherein the motion engine continuously changes a location of the base plate, and simultaneously, the holographic pattern is continuously changing.

3. The 3D printing system of claim 1, wherein the holographic pattern corresponds to a two-dimensional (2D) cross section of a 3D object to be printed.

4. The 3D printing system of claim 1,
wherein the projection component is configured to project the modulated light to a portion of the base plate, and
wherein the holographic pattern includes a focused beam spot.

5. The 3D printing system of claim 4, further comprising a scanning component coupled to the projection component, the scanning component configured to scan the base plate with the modulated light such that a location of the focused beam spot changes.

6. The 3D printing system of claim 1, further comprising a polarizer disposed between the projection component and the light modulator,
wherein in a first mode, the light modulator is configured to generate an intensity modulated light through the polarizer, and
wherein in a second mode, the light modulator is configured to generate a phase modulated light through the polarizer.

7. The 3D printing system of claim 6, further comprising a half-wave plate disposed between the projection component and the light modulator.

8. The 3D printing system of claim 6, wherein the light modulator is a first light modulator, further comprising a second light modulator,
wherein the first light modulator is configured to operate in the first mode, and the second light modulator is configured to operate in the second mode.

9. A device for printing a 3D object, comprising:
an imaging system, comprising:
a reservoir containing photosensitive material;
a base plate located in the reservoir; and
a motion engine configured to control a movement of the base plate; and
an optical system, comprising:
a light source configured to generate a source light;
a light modulator configured to receive the source light and generate a modulated light; and
a projection component configured to receive the modulated light and project the modulated light to expose the printing material to a holographic pattern,
wherein the printing material exposed to the holographic pattern is cured to form a 3D object on the base plate.

10. The device of claim 9, further comprising an optical coherence tomography system configured to generate a 3D volumetric image of the 3D object.

11. The device of claim 9,
wherein a predetermined thickness of the photosensitive material is exposed to the holographic pattern, and
wherein in response to exposure to the holographic pattern, the exposed photosensitive material is cured.

12. The device of claim 9, wherein the light modulator is configured to change a phase or intensity of a local portion of the modulated light.

13. The device of claim 12, wherein the light modulator includes a liquid crystal on silicon.

14. The device of claim 9,
wherein the base plate is located in the reservoir, and
wherein the motion engine continuously changes a location of the base plate, and simultaneously, the holographic pattern is continuously changing.

15. A method of printing a 3D object, comprising:
generating, by a light source, a source light;
generating, by a light modulator, a modulated light from the source light;
projecting, by a projection component, the modulated light to form a holographic pattern, in response to receipt of the modulated light, on printing material;
curing the printing material exposed to the holographic pattern; and
changing, by a motion engine, a vertical position of the base plate in response to curing of the printing material.

16. The method of claim 15, further comprising:
continuously changing the vertical position of the base plate, and simultaneously, continuously changing the holographic pattern.

17. The method of claim 15, further comprising focusing the modulated light onto a portion of the base plate.

18. The method of claim 17, further comprising scanning the base plate with the focused modulated light.

19. The method of claim 15, wherein the generating comprises:
modulating an intensity of the modulated light in a first mode, and
modulating a phase of the modulated light in a second mode.

20. The method of claim 15, further comprising generating a 3D volumetric image of the cured printing material.
